(19) United States
(12) Patent Application Publication
(10) Pub. No.: US 2010/0008837 A1
(43) Pub. Date: Jan. 14, 2010

(54) METAL IONIC CATALYST COMPOSITION AND A PROCESS THEREOF

(75) Inventors: Subraya Manjanath Hegde, Karnataka (IN); Chikkorao Kashinath Patil, Karnataka (IN); Sudhanshu Sharma, Karnataka (IN)

Correspondence Address: SHEPPARD, MULLIN, RICHTER & HAMPTON LLP, 990 Marsh Road, Menlo Park, CA, 94025, US

(73) Assignee: Indian Institute of Science, Bangalore, Kamataka (IN)

(21) Appl. No.: 12/377,762

(22) PCT Filed: Mar. 23, 2007
(86) PCT No.: PCT/IB07/00927

§ 371 Date: Feb. 17, 2009

(30) Foreign Application Priority Data
Aug. 24, 2006 (IN) 00106/CHE/2006

(51) Int. Cl. B01J 23/10; B01D 53/86; B01D 53/56; B01D 53/62; B01D 53/72

(52) U.S. Cl. 423/239.1; 502/304; 423/210; 423/247; 423/245.3

(57) ABSTRACT

The present invention relates to a metal ionic catalyst composition for the catalytic conversion of industrial pollutants and the process of preparation of the same. The present invention also relates to a process of coating of the said catalyst composition on a cordierite honeycomb.

### FIELD OF THE INVENTION

The present invention relates to a nanosized active catalyst comprising noble-metal ions catalytic conversion of auto exhaust gases including CO oxidation, NO reduction, ‘HC’ oxidation and a process of preparing the same. The present invention also relates to the process of coating of nanosized active catalyst on a honeycomb made of cordierite ceramic.

### BACKGROUND OF THE INVENTION

Cordierite honeycomb is used for preparation of catalytic converters, which are used for the treatment of industrial pollutants e.g. exhaust pollutants. The monoliths are coated with the active metal catalysts by various processes. Cordierite honeycomb monolith is generally first washcoated with γ-Al₂O₃. Most recent method of coating γ-Al₂O₃ is by sol-gel method. Jiang P., Lu G., Guo Y., Guo Yang., Zhang S. and Wang X. Surf. & Coat. Tech. 190 (2005) 314-320, recently have studied the wash coat properties of γ-Al₂O₃ prepared by sol-gel method.

Cordierite dipped in AlOOH (pseudo-boehmite) mixed with urea and 0.3M nitric acid in 2:1:5. Sol is calcined at 450° C. producing γ-Al₂O₃ coating, Duiesterwinkel, A. E. Clean Coal Combustion with In-Situ Impregnated Sol-Gel Sorbent. Ph.D. Thesis, Delft University of Technology, Delft, 1991.

After washcoating of γ-Al₂O₃ active phase is coated onto it. Well-optimized methods already exist for the preparation of various powder catalysts. These catalysts can simply be coated on a monolith support using slurry made of the same catalysts. The method is called slurry coating method.

For coating a catalyst using slurry method, Addiego, W. P.; Lachman, L. M.; Patil, M. D.; Williams, J. L.; Zaun, K. E. High Surface Area Washcoated Substrate and Method for producing Same. U.S. Pat. No. 5,212,130, 1993 (assigned to Corning Inc.), a number of components are needed; a solvent, properly sized catalyst particles, the binder and, optionally a surfactant and a temporary binder. All components of the coating slurry should be well mixed using a high-shear mixer until the slurry is homogeneous. A dried monolith is dipped in this slurry for a short period (few seconds). Thereafter drying is done horizontally while rotating the monolith continuously. Finally calcination is done typically at 400-900° C. depending upon the catalyst to be coated. In a recent study by Tagliaferri, S., Koppel, Rene A., Baiker, A., Appl. Catal. B: Environment, 15, 159-177, (1998). Behaviour of the different types of catalyst has been investigated. Compositions of various catalysts are: Pd/Al₂O₃, Pd—Rh/Al₂O₃, Pd/Ce/Al₂O₃, Pd—Rh/Ce/Al₂O₃. In the hand book of heterogeneous catalysis Hand Book of Heterogeneous Catalysis, Editors; G. Ertl, H. KnÖzinger and J. Weitkamp. Publisher; Wiley-Vch, vol. 4,1591-1594 (1997). Reactions over coated honeycomb have been demonstrated. Conversion temperatures are fairly high and in the range of 300-400° C.

### PRIOR ART

In the aforementioned patent citation it is evident that it describes a well known impregnation method in which support and catalytically active component are taken separately. After the calcinations the metal component is dispersed over support in the form of a metal.

Further, it is also evident from the above citations that they utilize high surface area refractive oxide such as activated alumina is taken and to that metal component in the form of an aqueous solution is added. Solution is made acidic by adding some acid like nitric acid. pH is maintained 2-2.5.

Furthermore, the above citations make use of Promoters, which are rare earth materials along with binder (zirconia). The whole mixture is ball milled to get slurry or a known particle size. This slurry is calcined to get a catalyst where metal is impregnated over the support Or the same slurry can be sprayed to a monolith carrier followed by the calcinations to get a monolith coated with the same catalyst. If desirable, oxygen storage component such as cerium dioxide can also be added to the slurry. The activated alumina should be dry enough to absorb all the aqueous solution of active metal component. To stabilize the high surface area metal oxide, a stabilizer such as lanthanum nitrate can be added.

Thus, it is evident from the prior art that all the specified compositions utilize various additives like binders, promoters and stabilizers. However, the instant invention is distinct as it does not utilize any of the additives as mentioned. In addition, it is also evident from the prior art that all the citations do utilize high processing temperatures to bring about the conversion of effluents. However, the instant invention was successfully able to arrive at low processing temperatures for conversion of the effluents.

Therefore, the instant invention is both novel and inventive. It is novel at it is able to arrive a t a catalyst composition which is achieved by dispersing the metal in the form of ions on the support. It is inventive as it is able to arrive at low full conversion temperature for conversion of effluents.

### Drawbacks of the Prior Art

a) Numbers of precursors are more as we have to use binders (temporary and permanent) and surfactant. Binder decreases the activity of the catalyst.

b) Adhesion between catalyst and the cordierite surface is poor.

### OBJECT OF THE PRESENT INVENTION

The principal object of the present invention is to develop a metal ionic catalyst composition.

Another object of the present invention is to develop a process for the preparation of metal ionic catalyst composition.

Yet another object of the present invention is to develop a method of coating the metal ionic catalyst composition over monolith surface.

Still another object of the present invention is to bring about catalytic conversion of industrial pollutants.

Still another object of the present invention is to bring about catalytic conversion of a gas comprising hydrocarbons, carbon monoxide and nitrogen oxide.

### STATEMENT OF THE INVENTION

The present invention is in relation to a metal ionic catalyst composition, said composition represented by formula, Ce_{1-x-y-z}MₓN_{y}K_{z}O_{2-δ} wherein, x is 0-0.09; y is 0-0.09; z is 0-0.09; δ is 0.01-0.09; and M, N, K is a metal; a process to obtain a metal ionic catalyst composition of the formula, Ce_{1-x-y-z}MₓN_{y}K_{z}O_{2-δ} wherein, x is 0-0.09; y is 0-0.09; z is 0-0.09; δ is 0.01-0.09; and M, N, K is a metal, said process comprising steps of dissolving stoichiometric amounts of metallic salts in a solvent to obtain a solution; and heating the solution to obtain the metal ionic catalyst composition; a process of coating the catalyst of Formula Ce_{1-x-y-z}MₓN_{y}K_{z}O_{2-δ} on monolithic surface, said process comprising step of coating the solution having stoichiometric amount of metallic salts on the surface followed by heating to obtain the coated monolith; and a method for treating a gas at low conversion temperature using a metal ionic catalyst composition of formula Ce_{1-x-y-z}MₓN_{y}K_{z}O_{2-δ}.

### BRIEF DESCRIPTION OF THE ACCOMPANYING DRAWINGS

FIG. 1: SEM images of bare cordierite.

FIG. 2: SEM image of cordierite coated with γ-Al₂O₃

FIG. 3: SEM image of cordierite coated with γ-Al₂O₃ followed by Ce₁₋ₓPdₓO_{2-δ}.

FIG. 4(a): XRD pattern of bare cordierite.

FIG. 4(b): XRD pattern of cordierite coated with Ce₁₋ₓPdₓO_{2-δ}.

FIG. 5(a): XPS spectra of Pd (3d_{5/2,3/2})

FIG. 5(b): XPS spectra Ce (3d).

FIG. 6: CO oxidation by O₂ over Ce_{0.98}Pt_{0.01}Rh_{0.01}O_{2-δ} powder catalyst concentration of CO and O₂ is 2 and 6 vol % respectively.

FIG. 7: % CO conversion for 1 vol % of CO plotted as a function of temperature.

FIG. 8: Percent NO conversion for 1 vol % NO by 1 vol % CO over monolith.

FIG. 9: Percent C₂H₂ conversion for 1 vol % C₂H₂ by 5 vol % O₂ over monolith.

FIG. 10: Three way catalytic performance of 10,000 ppm of CO, 2000 ppm of NO, 2000 ppm of C₂H₂ in presence of 7000 ppm of O₂ monolith.

Table 1: Shows the comparison between commercial available monolithic catalyst and our monolithic catalyst in metal loading, washcoat loading and conversion temperature of CO conversion.

### DETAILED DESCRIPTION OF THE PRESENT INVENTION

The present invention is in relation to a metal ionic catalyst composition, said composition represented by formula, Ce_{1-x-y-z}MₓN_{y}K_{z}O_{2-δ} wherein, x is 0-0.09; y is 0-0.09; z is 0-0.09; δ is 0.01-0.09; and M, N, K is a metal.

Another embodiment of the present invention wherein the metal is selected from a group comprising Pd, Pt, Rh, Ru, Zr, Ni and Cu.

Yet another embodiment of the present invention wherein the catalyst is Pd_{0.02}Ce_{0.98}O_{2-δ}, Pt_{0.05} Rh_{0.05}Ce_{0.99}O_{2-δ} and Ce_{0.98}Pt_{0.01}Rh_{0.01}O_{2-δ}

Yet another embodiment of the present invention wherein the catalyst composition is in a fine powder form.

The present invention is in relation to a process to obtain a metal ionic catalyst composition of the formula, Ce_{1-x-y-z}MₓN_{y}K_{z}O_{2-δ} wherein, x is 0-0.09; y is 0-0.09; z is 0-0.09; δ is 0.01-0.09; and M, N, K is a metal, said process comprising steps of:
a) dissolving stoichiometric amounts of metallic salts in a solvent to obtain a solution; and
b) heating the solution to obtain the metal ionic catalyst composition.

Another embodiment of the present invention wherein the metal is selected from a group comprising Pd, Pt, Rh, Ru, Zr, Ni and Cu.

Yet another embodiment of the present invention wherein Pt and Rh are derived from H₂PtCl₆ and RhCl₃.

Still another embodiment of the present invention wherein Pt and Pd are derived from H₂PtCl₆ and PdCl₂.

Still another embodiment of the present invention wherein Cu and Pd are derived from Cu (NO₃)₂ and PdCl₂.

Still another embodiment of the present invention wherein heating the solution at temperature ranging between 200-1500° C.

Still another embodiment of the present invention wherein the catalyst has a particle size in the range of 25-30 nm.

Still another embodiment of the present invention wherein the catalyst is in fine crystalline powder form.

The present invention is in relation to a process of coating the catalyst of formula Ce_{1-x-y-z}MₓN_{y}K_{z}O_{2-δ} on monolithic surface, said process comprising step of coating the solution having stoichiometric amount of metallic salts on the surface followed by heating to obtain the coated monolith.

Another embodiment of the present invention wherein heating at a temperature ranging between 400-700° C.

The present invention is in relation to a method for treating a gas at low conversion temperature using a metal ionic catalyst composition of formula Ce_{1-x-y-z}MₓN_{y}K_{z}O_{2-δ}.

Another embodiment of the present invention wherein said gas comprises carbon monoxide, hydrocarbons and nitrogen oxide.

Yet another embodiment of the present invention wherein the carbon monoxide conversion is 100% at temperature less than 130° C.

Still another embodiment of the present invention wherein the hydrocarbons conversion is 100% at temperature less than 240° C.

Still another embodiment of the present invention wherein the nitrogen oxide conversion is 100% at temperature less than 175° C.

Still another embodiment of the present invention wherein the three way conversion is 100% at temperature less than 225° C.

Still another embodiment of the present invention wherein the composition is used for conversion of pollutants.

The present invention is illustrated by the following examples, which are set forth to illustrate the present invention and are not construed as limiting thereof.

### EXAMPLE 1

Preparation of Pt_{0.05}Rh_{0.05}Ce_{0.99}O_{2-δ}

For the preparation of 0.5 atom % Pt-0.5 atom % Rh in CeO₂, (NH₄)₂Ce(NO₃)₆, H₂PtCl₆, RhCl₃.xH₂O and ODH were taken in the mole ratio 0.99:0.005:0.005:2.376 in minimum volume of water (˜30 cm³) in a borosilicate dish of 130 cm³ capacity followed by introduction of the dish containing the redox mixture into a muffle furnace maintained at ˜350° C. Solution burns after dehydration with a flame (˜1000° C.) yielding a voluminous solid product within 2 minutes. The flame itself lasts for 10-20 seconds and within a time interval of 60 seconds the temperature falls from ˜1000° C. to ˜350° C.

### EXAMPLE 2

Coating the Monolith with Pd_{0.02}Ce_{0.98}O_{2-δ}

0.06 M ceric ammonium nitrate and 0.144 M ODH with 1.2×10⁻³ M PdCl₂ are dissolved in 150 mL of water to get a clear solution. Monolith is first dried at about 200° C. After cooling it is dipped in the precursor solution for a few seconds. Blowing the air shakes out excess solution. Monolith is finally fired at 450-500® C. Process is repeated until we get the desired catalyst loading. Sonication is carried out at the end to remove blockage in the channels. Finally weight gain is calculated.

The present invention will now be further illustrated by the following Figures and examples, which do not limit the scope of the invention in any way.

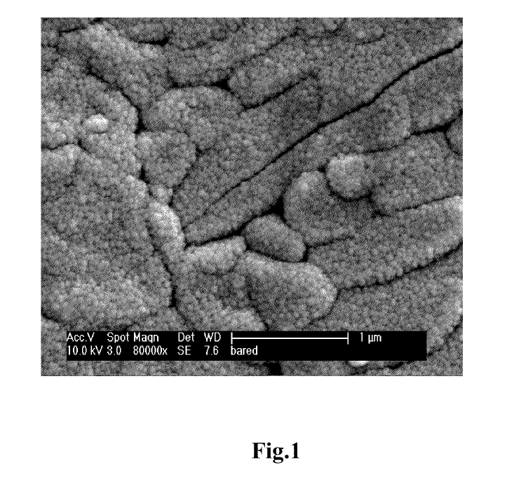

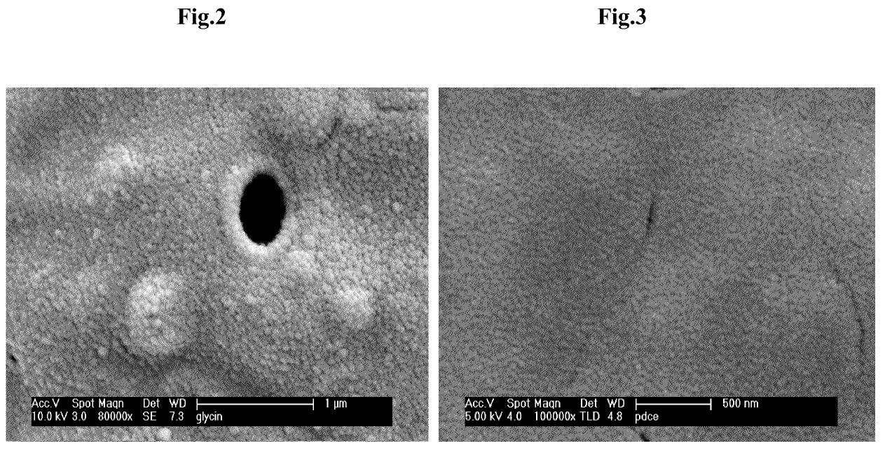

In FIGS. 1, 2, and 3, SEM of bare monolith, monolith coated with γ-Al₂O₃ and monolith with γ-Al₂O₃+active catalyst phase are shown. In FIG. 1 we see the plate like morphology while in FIG. 2 we see the white porous material over the surface. FIG. 3 shows the Ce_{0.98}Pd_{0.002}O_{2-δ} surface of cordierite. Difference in the surface morphology is apparent.

The active catalyst phase is coated over the wash-coated honeycomb surface. In the present investigation we have coated Ce_{0.98}Pd_{0.02}O_{2-δ} over honeycomb surface.

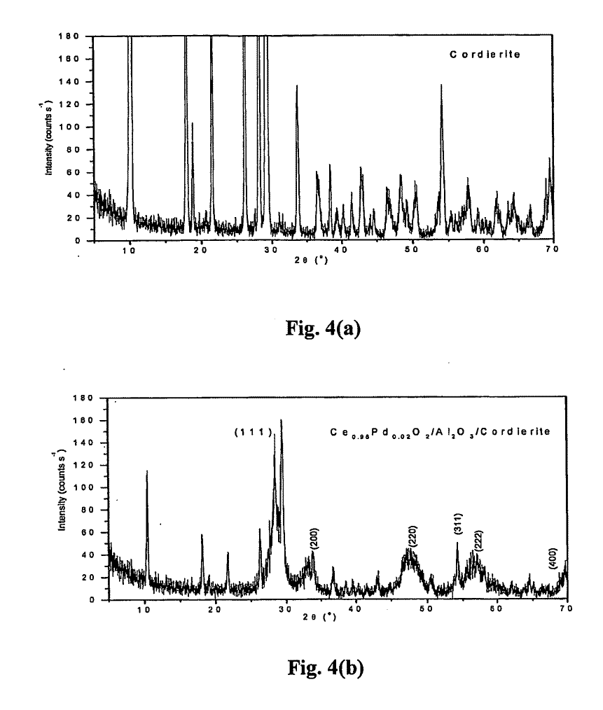

XRD results given in the following FIG. 4(a) shows the XRD of bare cordierite and (b) that of alumina+Ce_{0.98}Pd_{0.02}O_{2-δ}. Diffraction lines due to active ceria phase are identified in FIG. 4(b).

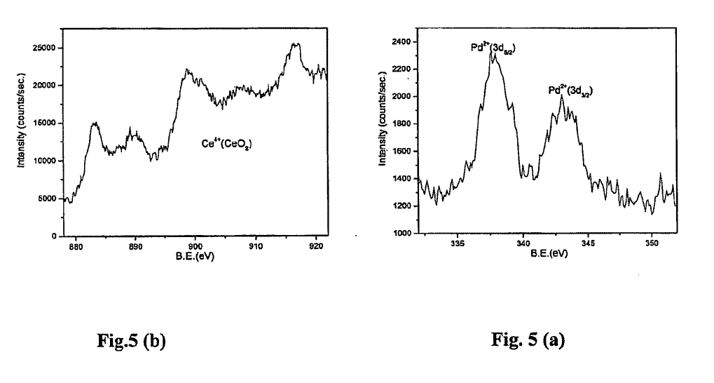

An X-ray photoelectron spectra is given in FIGS. 5(a) and 5(b). It shows the oxidation state of palladium is +2 and not in zero valent state. Cerium dioxide can also be seen over cordierite surface with Ce in +4 state.

### EXAMPLE 3

Performance of Ce_{0.98}Pt_{0.01}Rh_{0.00}O_{2-δ} Metal Ionic Powder Catalyst:

CO oxidation over this catalyst is carried out with 150 mg of the catalyst with 2 vol % of CO and 6 vol % of O₂ and at total flow of 100 cc/min which gives rise to a gas hourly space velocity of 43000 hr⁻¹. 100% conversion occurs below 130° C. Actual rate of CO conversion is 2×10⁻⁶ moles/gm/sec at 110° C.

Rate of C₂H₄ oxidation over the catalyst Ce_{0.98}Pt_{0.01}Rh_{0.00}O_{2-δ} at 200° C. is 1.2×10⁻⁶ moles/gm/sec.

Rate of NO reduction by CO over the same active catalyst at 150° C. is 1.5×10⁻⁶ moles/gm/sec.

### EXAMPLE 4

Performance Over Pd_{0.02}Ce_{0.98}O_{2-δ} Coated Monolithic Catalyst:

Honeycombs coated with 2% Pd/CeO₂ are investigated through various catalytic reactions like CO oxidation by O₂, CO+NO reaction both in presence and absence of O₂ with different composition. Reactions are done in a temperature programmed reaction (TPR) system. Two coated honeycombs (length 2.5 cm/honeycomb, diameter 1.876 mm and channel density is 74/cm²) are taken in the reactor and gases are passed through it. Total flow was kept 100 cc/min for all the studies. This gives rise to the space velocity 55600 lit⁻¹ hr⁻¹ in side the channel. Percent conversions are plotted against the temperature.

### EXAMPLE: 5

Carbon Monoxide Oxidation:

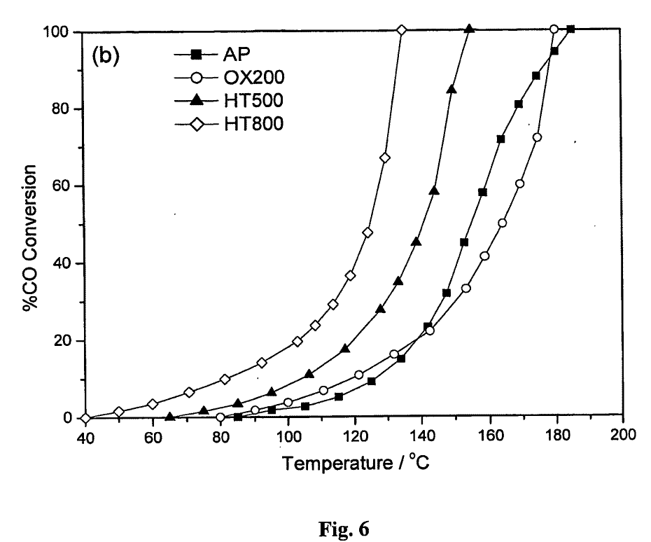

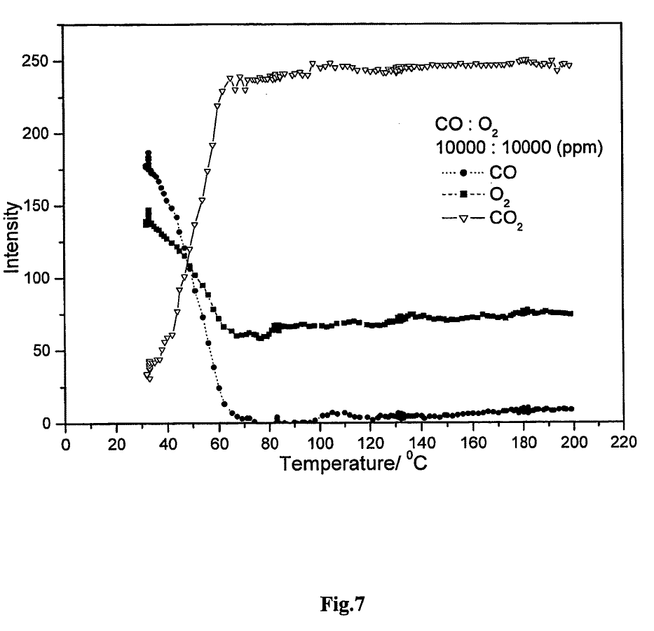

Percent CO conversion for CO:O₂, 1 vol % CO and 1 vol % O₂ at 100 cc/min. (55600 lit⁻¹ hr⁻¹ space velocity in the channel) is given in FIG. 6. Clearly below 75° C. CO is converted completely to CO₂. At space velocity 213000 lit⁻¹-hr⁻¹ 100% CO conversions occurs at 130° C. as shown in FIG. 7.

NO Reduction by CO:

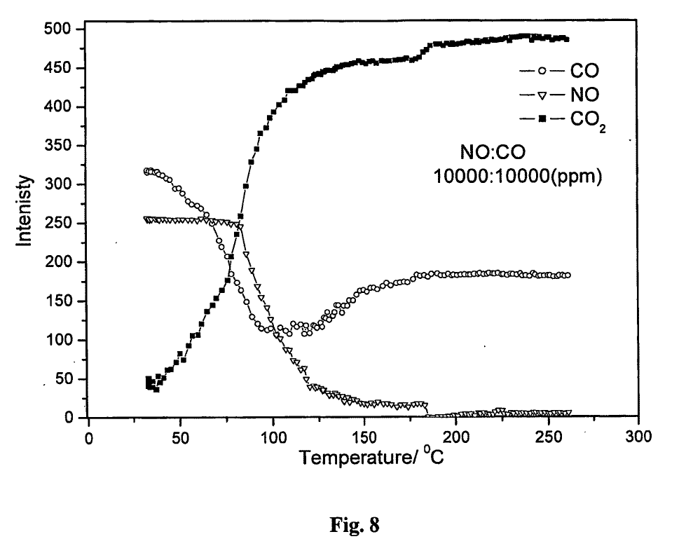

1 vol % NO (10,000 ppm) and 1 vol % CO (10,000 ppm) gas mixture at 55600 lit⁻¹ hr⁻¹ shows 100% conversion of NO below 175° C. as can be seen in FIG. 8.

Acetylene Oxidation:

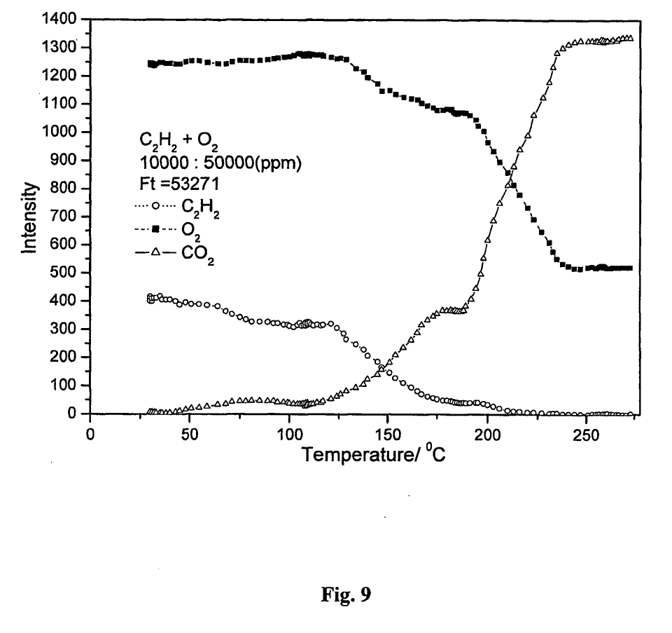

FIG. 9 shows the acetylene oxidation by O₂ with 1 vol. % acetylene and 5 vol. % oxygen. Clearly below 240° C., acetylene is completely converted into H₂O and CO₂.

### EXAMPLE: 6

Three-Way Catalytic Performance Over Pd_{0.02}Ce_{0.98}O_{2-δ} Coated Honeycomb Catalyst:

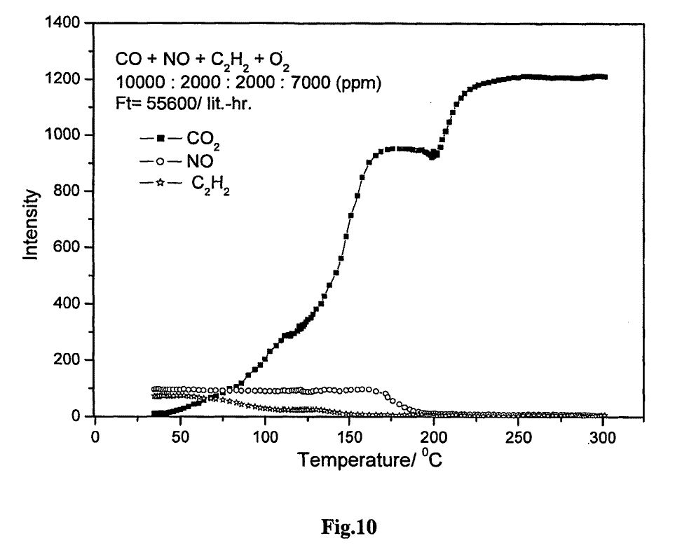

Three-way catalytic Reactions with Pd_{0.02}Ce_{0.98}O_{2-δ} over honeycomb have been investigated. A gas mixture containing 10,000 ppm of CO, 2000 ppm of C₂H₂, 2000 ppm of NO and 7000 ppm of O₂ is passed over the monolith at 55600 lit⁻¹ hr⁻¹ space velocity. Total reductants are equal to 12000 ppm and total oxidants are equal to 15000 ppm equivalent to [O]. 2000 ppm of NO gives 2000 equivalent of [O] and 14000 ppm of [O] from 7000 ppm of O₂. Thus there is a small excess of 1000 ppm of [O]. Total conversion profile is given in FIG. 10. As can be seen from increase in CO₂ vs. temperature curve below 225° C., total conversion of CO, NO and C₂H₂ occur. CO and C₂H₂ are converted before NO conversion. NO is fully converted below 200° C. Thus, under stoichiometric and even with ˜15% excess oxygen the pollutants CO, NO and ‘HC’ (acetylene) are converted to CO₂, N₂ and H₂O below 225° C.

The performance of the monolith is shown in Table: 1 and is found that it is extremely high at lower temperature for CO, NO as well as ‘HC’ as compared to the current literature. The details of which can be found in reference, Indian Institute of Science Bangalore, 560012.

TABLE 1

| | Metal | | | Full conversion |
|---|---|---|---|---|
| | loading | Washcoat | Space Velocity | temp. (° C.) |
| Catalyst | (gm/lit.) | loading | (lit⁻¹ h⁻¹) | CO oxidation |
| ^{a}Pd/Al₂O₃ | 1.1 | 108.9 (gm/lit.) | 679405 | 310 |
| ^{a}Pd—Rh/Al₂O₃ | 1.32 | 108.68 (gm/lit.) | | 240 |
| ^{a}Pd/Al₂O₃—CeO₂ | 1.1 | 108.9 (gm/lit.) | | 260 |
| ^{a}Pd—Rh/Al₂O₃—CeO₂ | 1.32 | 108.68 (gm/lit.) | | 270 |
| ^{b}Pd_{0.02}Ce_{0.98}O_{2-δ} | 0.318 | 17.28 (gm/lit) | 53000 | 75 |
| | | or 5 wt % | 213000 | 130 |

^{a}Commercial varieties
^{b}A metal ionic catalyst composition of instant invention

We claim:

1. A metal ionic catalyst composition, said composition represented by formula, Ce_{1-x-y-z}MₓN_{y}K_{z}O_{2-δ} wherein, x is 0-0.09; y is 0-0.09; z is 0-0.09; δ is 0.01-0.09; and M, N, K is a metal.

2. The composition as claimed in claim 1, wherein the metal is selected from a group comprising Pd, Pt, Rh, Ru, Zr, Ni and Cu.

3. The composition as claimed in claim 1, wherein the catalyst is Pd_{0.02}Ce_{0.98}O_{2-δ}, Pt_{0.05} Rh_{0.05}Ce_{0.99}O_{2-δ} and Ce_{0.98}Pt_{0.01}Rh_{0.01}O_{2-δ}

4. The composition as claimed in claim 1, wherein the catalyst composition is in a fine powder form.

5. A process to obtain a metal ionic catalyst composition of the formula, Ce_{1-x-y-z}MₓN_{y}K_{z}O_{2-δ} wherein, x is 0-0.09; y is 0-0.09; z is 0-0.09; δ is 0.01-0.09; and M, N, K is a metal, said process comprising steps of:
c) dissolving stoichiometric amounts of metallic salts in a solvent to obtain a solution; and
d) heating the solution to obtain the metal ionic catalyst composition.

6. The process as claimed in claim 5, wherein the metal is selected from a group comprising Pd, Pt, Rh, Ru, Zr, Ni and Cu.

7. The process as claimed in claim 6, wherein Pt and Rh are derived from H₂PtCl₆ and RhCl₃.

8. The process as claimed in claim 6, wherein Pt and Pd are derived from H₂PtCl₆ and PdCl₂.

9. The process as claimed in claim 6, wherein Cu and Pd are derived from Cu (NO₃)₂ and PdCl₂.

10. The process as claimed in claim 5, wherein heating the solution at temperature ranging between 200-1500° C.

11. The process as claimed in claim 5, wherein the catalyst has a particle size in the range of 25-30 nm.

12. The process as claimed in claim 5, wherein the catalyst is in fine crystalline powder form.

13. A process of coating the catalyst of Formula Ce_{1-x-y-z}MₓN_{y}K_{z}O_{2-δ} on monolithic surface, said process comprising step of coating the solution having stoichiometric amount of metallic salts on the surface followed by heating to obtain the coated monolith.

14. The process as claimed in claim 13, wherein heating at a temperature ranging between 400-700° C.

15. A method for treating a gas at low conversion temperature using a metal ionic catalyst composition of formula Ce_{1-x-y-z}MₓN_{y}K_{z}O_{2-δ}.

16. The method for treating a gas as claimed in claim 15, wherein said gas comprises carbon monoxide, hydrocarbons and nitrogen oxide.

17. The method for treating a gas as claimed in claim 15, wherein the carbon monoxide conversion is 100% at temperature less than 130° C.

18. The method for treating a gas as claimed in claim 15, wherein the hydrocarbons conversion is 100% at temperature less than 240° C.

19. The method for treating a gas as claimed in claim 15, wherein the nitrogen oxide conversion is 100% at temperature less than 175° C.

20. The method for treating a gas as claimed in claim 16, wherein the three way conversion is 100% at temperature less than 225° C.

21. The method for treating as claimed in claim 15, wherein the composition is used for conversion of pollutants.
